(19) United States
(12) Patent Application Publication
(10) Pub. No.: US 2015/0263949 A1
(43) Pub. Date: Sep. 17, 2015

(54) COMPRESSED SOURCE ROUTING ENCODING

(71) Applicant: Huawei Technologies Co., LTD, Guangdong (CN)

(72) Inventors: Evelyne ROCH, Quebec (CA); Peter ASHWOOD-SMITH, Quebec (CA)

(21) Appl. No.: 14/641,060

(22) Filed: Mar. 6, 2015

Related U.S. Application Data
(60) Provisional application No. 61/952,011, filed on Mar. 12, 2014.

(51) Int. Cl. H04L 12/741; H04L 29/06

(52) U.S. Cl. CPC H04L 45/74; H04L 69/22; H04L 2209/34

(57) ABSTRACT

A method of generating identifiers associated with a communication network is described. In one approach, a global encoding scheme minimizes header length by encoding identifiers of network interconnects forming a packet network path. The method includes a controller accessing topology information associated with the communication network including identifiers of nodes and identifiers of interconnects between nodes of the communication network, the interconnects having associated parameters. The controller also generates codewords for the identifiers of the interconnects, the size of each codeword being based on a parameter of an associated interconnect. The controller further generates a mapping between the identifiers of the interconnects and the codewords, and stores the mapping into memory. The method supports source routing in a compact format for varied network configurations.

### CROSS-REFERENCE TO RELATED APPLICATIONS

This application claims the benefit of U.S. Provisional Application No. 61/952,011, filed Mar. 12, 2014, which is incorporated by reference herein.

### FIELD

Embodiments of the present invention generally relate to the field of packet routing in electronic data networks. More specifically, embodiments of the present invention are related to providing efficient source routing suitable for a variety of communication network configurations.

### BACKGROUND

In packet-switched communication networks, routing techniques coordinate the forwarding of packets from one node (or ‘hop’) to the next. The intermediate nodes encountered during routing include network hardware devices such as access points, routers, switches, firewalls and bridges, etc.

In source routing, identifiers of all the devices in the complete route from the source node to the destination node are included in each packet header by the source node. The subsequent node looks at the packet header to determine the next hop, as opposed to having intermediate nodes look at a routing table to determine the next hop. Large routes in large networks require a large number of hops, which leads to very large headers. Prior solutions for encoding source routed hops can consume significant space or overhead, resulting in inefficiency, complicating scaling in large networks, and utilizing bandwidth for the packet header that could otherwise be used to transmit additional packets.

### SUMMARY

Embodiments of the present invention offer several advantages over existing routing techniques. This disclosure supports source routing in a compact or compressed format for varied network configurations. Additionally, there is no hard limit on the number of interfaces or hops between the source and destination nodes. The systems and methods described herein can advantageously reduce the required size and/or length of source routing headers in the network for all flows by assigning variable-length codewords to interfaces or port numbers. In addition, some embodiments allow path reversal, that is, the destination node may take the list of hops and use it to send a response back to the source node and collect links traversed with no additional overhead.

An embodiment in accordance with the present invention provides a centrally optimized, variable-size, compressed source routing encoding scheme. This disclosure describes centrally optimized software defined network (SDN) or central network controller assignment methods for compressed variable-length codewords representing interface identifiers, header decoding methods, and packet processing actions.

According to one embodiment of the present invention, a method of generating identifiers associated with a communication network includes a controller accessing topology information associated with the communication network including identifiers of nodes and identifiers of interconnects between nodes of the communication network, the interconnects having associated parameters. The controller also generates codewords for the identifiers of the interconnects, the size of each codeword being based on a parameter of an associated interconnect. The controller further generates a mapping between the identifiers of the interconnects and the codewords, and stores the mapping into memory.

According to another embodiment of the present invention, a method of routing a packet over a communication network includes receiving from a central controller, with a processor associated with a node in the communication network, a mapping between codewords and identifiers of interconnects associated with the node, the size of each codeword being based on a respective parameter associated with each interconnect. The method also includes receiving a routing path for a packet including an ordered set of the codewords that corresponds to a sequence of interconnects from the node to a destination node in the communication network, including the routing path in a header associated with the packet, and identifying an interconnect that corresponds to a codeword of the ordered set of codewords for routing said packet.

According to yet another embodiment of the present invention, a computer program product is described for generating codewords associated with packet routing in a communication network and includes a non-transitory, computer-readable storage medium encoded with instructions adapted to be executed by a processor to implement a method including accessing topology information associated with the communication network comprising identifiers of nodes and identifiers of interconnects between nodes of the communication network, the interconnects having respective associated parameters. The method also includes generating codewords for the identifiers of the interconnects. The size of each codeword is based on a parameter of an associated interconnect. The method further includes generating a mapping between the identifiers of the interconnects and the codewords, compiling a routing path including an ordered set of the codewords that correspond to a sequence of interconnects from a source node to a destination node in the communication network, and sending the routing path to said source node.

The details of one or more embodiments of the invention are set forth in the accompanying drawings and the description below. Other features, objects, and advantages of the invention will be apparent from the description and drawings, and from the claims.

### DESCRIPTION OF THE DRAWINGS

The accompanying drawings, which are incorporated in and form a part of this specification, illustrate embodiments of the invention and, together with the description, serve to explain the principles of the invention.

FIG. 1 is a block diagram of a computer system upon which embodiments of the present invention may be implemented.

FIG. 2 is a diagram illustrating a packet-switched network.

FIG. 3 is a table representing a set of variable-length codewords suitable for use with the network of FIG. 2 in accordance with embodiments of the present invention.

FIG. 4 is a table representing example indicators, or symbols, that may be assigned to network links represented in FIG. 2 in accordance with embodiments of the present invention.

FIG. 5 is a table representing a source-routed path encoding header for the data flow path represented in FIG. 2 in accordance with embodiments of the present invention.

FIG. 6 is an illustration of a data packet header in accordance with embodiments of the present invention.

FIG. 7 is a flowchart representing a method of source routing in a packet-switched network in accordance with embodiments of the present invention.

FIG. 8 is a flowchart representing a method of source routing in a packet-switched network in accordance with embodiments of the present invention.

### DETAILED DESCRIPTION

Embodiments of the present invention offer several advantages over existing routing techniques. This disclosure supports source routing in a compact or compressed format for varied network configurations. Additionally, there is no hard limit on the number of interfaces or hops between the source and destination nodes. The systems and methods described herein can advantageously reduce the required size and/or length of certain source routing headers in the network by assigning variable-length codewords to interfaces or port numbers. In addition, some embodiments allow path reversal, that is, the destination node may take the list of hops and use it to send a response back to the source node and collect links traversed with no additional overhead.

An embodiment in accordance with the present invention provides a centrally optimized, variable-size, compressed source routing encoding scheme. This disclosure describes centrally optimized software defined network (SDN) or central network controller assignment methods for compressed variable-length codewords representing interface identifiers, header decoding methods, and packet processing actions.

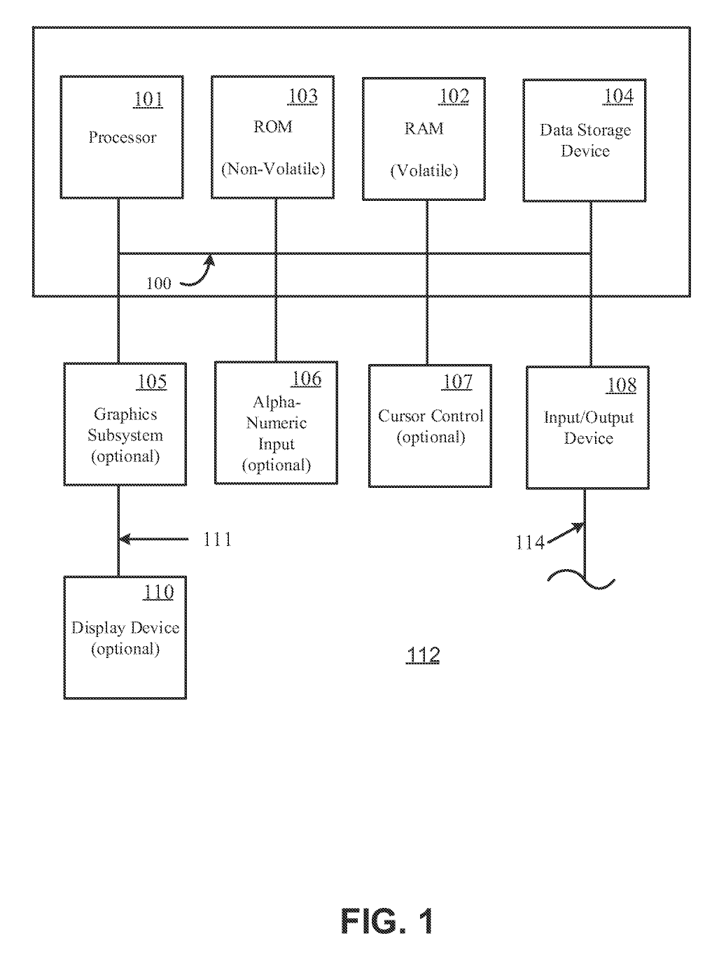

As illustrated in FIG. 1, a general computer system 112 that may implement the source routing encoding scheme disclosed herein includes a processor 101, non-volatile read-only memory (ROM) 103, volatile random-access memory (RAM) 102, a data storage device 104, an optional graphics subsystem 105, an optional alphanumeric input device 106, an optional cursor control device 107, an input/output (I/O) device 108 and an optional display device 110. The various components may be interconnected, or coupled, by a data bus 100 or other data link 111.

The processor 101, ROM 103, RAM 102, and data storage device 104 may be part of a general computing device, such as a personal computer (PC), a controller, a server, or a mainframe computer. In various embodiments, the computer system 112 may be coupled to a communication network by way of the data link 114.

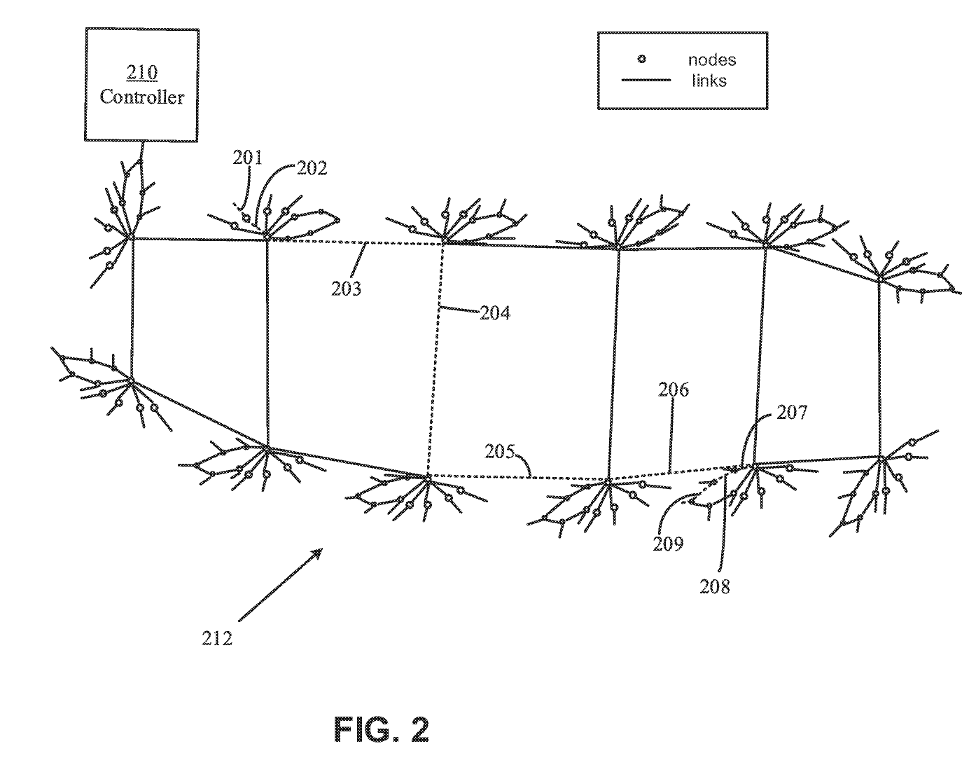

Referring to FIG. 2, the central network controller 210 identifies the network topology including all nodes, links and link capacities throughout the network 212. The central network controller 210 can be implemented, for example, by the general computer system 112 of FIG. 1. Similarly, each of the individual nodes in the network 212 can be implemented, for example, by the general computer system 112 of FIG. 1.

Based on the identified topologies, the central controller 210 determines the encoding of variable-length codewords to represent for forwarding the packet on a network interconnect, such as a network interface or link. The central controller 210 reserves special codewords to indicate how to decode the header, and/or to indicate that some packet processing actions should be performed, such as end of list, end of reverse list, local packet processing, etc. In some embodiments, the codewords that represent the interfaces at both ends of a link are assigned the same value to enable easier path reversal and thereby provide lower overhead to capture the list of links traversed.

The centralized controller 210 is configured to assign indicators to network interconnects, for example, network links or interfaces, associated with each node in the network for the purpose of forwarding packets based on a routing path header consisting of an ordered set of codewords. An example routing path is shown along the sequence of link 201, link 202, link 203, link 204, link 205, link 206, link 207, link 208 and link 209.

Indicators may include, for example, alphanumeric characters, colors, or other symbols. Each indicator may correspond to any one of numerous optimization parameters, such as a capacity, historical traffic flow, or predicted future traffic flow across the relevant interconnect. Of course, A computer-implemented process, such as a weighted graph-coloring algorithm, optimizes the assignment of indicators to the links or interfaces.

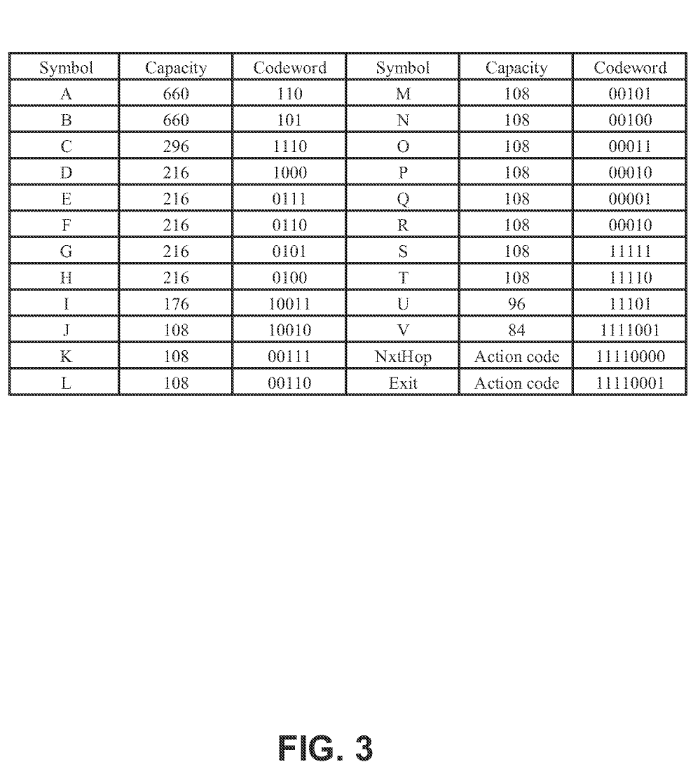

For example, as depicted in FIG. 3, the centralized controller 210 assigns symbols, or indicators, including the letters “A”-“V,” “NxtHop” and “Exit” to the various links throughout the network. The symbols are assigned corresponding to decreasing capacity of each of the interconnects in one example. In other embodiments, the symbols may be assigned according to a different parameter, such as a historical traffic flow or predicted future traffic flow across the relevant interconnect.

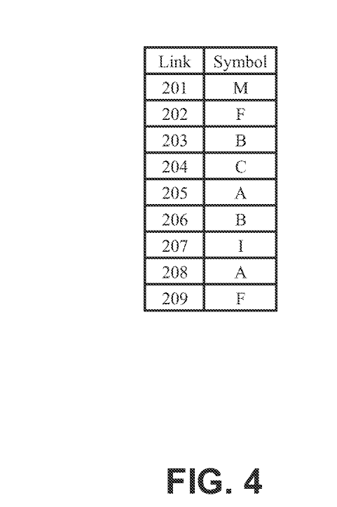

Although each interface or link associated with a particular node is assigned a unique indicator, use of a particular indicator may be repeated throughout the network in association with different nodes. Thus, as shown in FIG. 4, for example, with regard to the network 212 of FIG. 2, the symbol “A” is assigned to both link 205 and link 208, the symbol “B” is assigned to both link 203 and link 206, and the symbol “F” is assigned to both link 202 and link 209. In addition, as shown in FIG. 4, the symbol “M” is assigned to link 201, the symbol “C” is assigned to link 204, the symbol “I” is assigned to link 207.

Referring back to FIG. 3, the centralized controller 210 assigns variable-length compressed codewords to the indicators. The length of the assigned codewords depends, for example, on the probability of occurrence of network traffic flow on the network interconnects, such as network links or interfaces, to which the indicators are assigned. The indicators are assigned to network interfaces and links in such a way that the number of indicators is reduced For each indicator, or symbol, the capacity of all the interconnects assigned to the indicator are added together to generate an aggregate capacity. An algorithm, such as a Shannon-Fano algorithm, a Huffman code algorithm, or other arithmetic algorithm, can be used to determine a variable-length compressed codeword for each indicator's relative capacity. In other embodiments, the variable-length compressed codeword can correspond to some other parameter, such as historical traffic flow, or predicted future traffic flow across the relevant interconnect. Any suitable process can be used for the compression.

The codewords are assigned to the interconnects based on a criterion, for example, minimizing the average header length throughout the network or on specific links. To this end, for example, as shown in FIG. 3, the shortest codewords are assigned to the symbols associated with the greatest capacity, or other parameter, and longer codewords are assigned to the symbols associated with less capacity, or other parameter. According to some embodiments, the parameter may be based on the statistical probability of occurrence of network traffic flow on the network interconnects inferred from interface capacity. In other embodiments, the criteria may be inferred from another parameter, such as historical traffic flow, or predicted future traffic flow across the relevant interconnect.

Additional variable-length codewords can be assigned for special decoding or packet processing actions. For example, as shown in FIG. 3, codewords are assigned to actions representing the next hop (“NxtHop”) and the end of a routing list (“Exit”). In some embodiments, the centralized controller 210 assigns the same codeword value to interfaces, such as ports, at both ends of a link. When forwarding based on links, path reversal may be advantageously achieved by changing the order of links in the header to create a reverse routing path list and simultaneously capturing the number of hops traversed without impacting header size. The source node inserts special decoding or packet processing action codewords into the routing path to generate the destination header.

Special decoding actions generally relate to the structure of the hop list. According to some embodiments of the present invention, special decoding actions include creating and/or maintaining a pointer to the next hop on the path, the beginning of the reverse hop list, the beginning of a traversed path list, or the list of hops traversed so far, the end of the reverse hop list, the end of the traversed path list, and/or the end of the routing path list. Packet processing actions are used to indicate if the packet should be locally processed based on the packet contents, as opposed to the source routing header. Packet processing actions include, for example, removing the source routing header and processing the packet locally, which may result in, for example, 1) treating the packet as an operations, administration and maintenance (OAM) packet, 2) forwarding the packet based on an embedded header, 3) sending a packet to the network controller, 4) discarding the packet, and/or 5) incrementing one or more counters.

In an embodiment, the compressed, variable-length codeword set is chosen, or generated, implementing a global encoding optimization scheme. The central controller 210 is configured to automatically discover the network topology of the network and gather information about all nodes, interfaces and links interconnecting the nodes, including link capacity and other parameter, such as historical traffic flow, or predicted future traffic flow. The topology may be enhanced with network planning data related to future network expansions.

The central controller 210 selects a compressed variable-length codeword set to represent the interfaces on which traffic can be forwarded. The codeword set is used in constructing the packet header. Optimization may take the individual capacities, historical flows or predicted flows of the links or interfaces into account. In some embodiments, selecting codewords in this way can reduce average header length throughout the network 212. In an alternative embodiment, the codewords are selected to reduce header length on a particular link or subset of links in the network 212.

For example, the variable-length codewords may be assigned based on the statistically probable number of data packets each interconnect is likely to carry in the future. In some embodiments, the probability may be inferred from interface capacity or additional topology information, such as the current or planned interface utilization based on existing or expected traffic flows. In an alternative embodiment, the interconnects may be assigned different codewords to identify that they have not yet been processed or that they have already been processed, thereby eliminating the need for a special codeword to represent the next hop.

The central controller 210 downloads, or sends, the list of codewords to all of the nodes with a mapping from each codeword to either forward the packet by way of a specific local interface or to perform another decoding or packet processing action. In an alternative embodiment, for each network node, the central controller downloads, or sends, to each individual node only a subset of the codewords, e.g. the set of codewords that are relevant to that node, rather than the entire set of codewords.

Thus, in order to assign variable length compressed interface identifiers, the central controller 210 can implement the following example process, or pseudocode:
a weighted graph-coloring algorithm optimizes the assignment of symbols to links or interfaces;
for each color, add the capacity of all the links assigned to the color;
a Huffman code algorithm finds the optimal variable-length compressed interface identifier for each colors's relative capacity; and
the central controller 210 downloads the list of all compressed variable-length codes to each nodes with the mappings to interface identifiers or special actions.

Referring again to FIG. 2, it is appreciated that central controller 210 provides source routed path encodings to source nodes for traffic flows. For example, as indicated in FIGS. 3-4, the routing path from link 201 through link 209 may be represented by the indicator listing:
M F B C A B I A F
   Equivalently, the routing path from link 201 through link 209 may be represented by the codeword listing:
00101-0110-101-1110-110-101-10011-110-0110

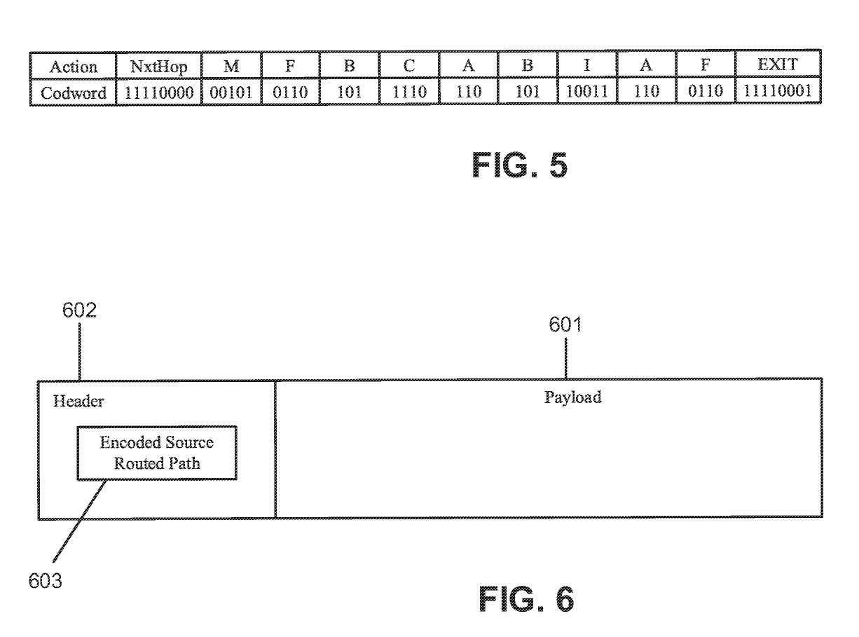

Before inserting the routing path into the header, the source node 201 optionally adds one or more special action codewords to the routing list. Referring to FIG. 5, for example, the source node 201 optionally adds the codewords mapped to the next hop (“NxtHop”) and end of list (“Exit”) special actions to generate the source routed list or header represented by the indicator listing:
NxtHop M F B C A B I A F Exit
   or, equivalently, by the codeword listing:
11110000-00101-0110-101-1110-110-101-10011-110-0110-11110001

The example header includes codewords to represent local interfaces and special decoding or packet processing actions based on globally assigned codewords (as represented in FIG. 3) with symbols assigned to the links based on FIG. 4. The source node at link 201 inserts the encoded source routed path encoding in the header of the packet. An example data packet is illustrated in FIG. 6. The packet includes a data, or payload, segment 601 and a header segment 602. The encoded source routed path 603 is embedded in the header segment 602.

Each node looks at the code, that is, each node decodes the packet header encoded source routed path. The node proceeds according to the following process, or pseudocode:
If the code represents a local interface identifier, then the node:
   removes, or pops, the codeword from the routing path,
   adds the popped code in the path reversal list (which also captures the traversed link list if interface identifiers are the same at both ends of the link), or
   adds the port code for the interface where the packet was received in the reversal list,
   converts the pre-processing port/interface code into the equivalent post-processing port/interface code value to indicate it was already processed;
If the code represents a special action, then the corresponding action is taken.

Thus, as the packet traverses the network, following each hop indicated in the routing list, each successive node optionally pops, or removes, the most recently completed hop, or interconnect, from the routing path. Each successive node then optionally adds the completed hop to a list of hops traversed and/or a reverse routing path list. Alternatively, if the interfaces at both ends of the corresponding link do not have the same codeword, the node adds the codeword corresponding to the interface where the packet was received in the reverse routing path list.

Each node then decodes the next codeword in the header. Alternatively, each node converts the pre-processing interface codeword into the equivalent post-processing interface codeword value to indicate the codeword has been processed before forwarding the packet on the specified interface. If the codeword represents a special decoding or packet processing action, the corresponding action is taken. Otherwise, if the codeword represents forwarding to a local interface, the node then forwards the packet on the interface corresponding to the next codeword to send the packet towards the next hop.

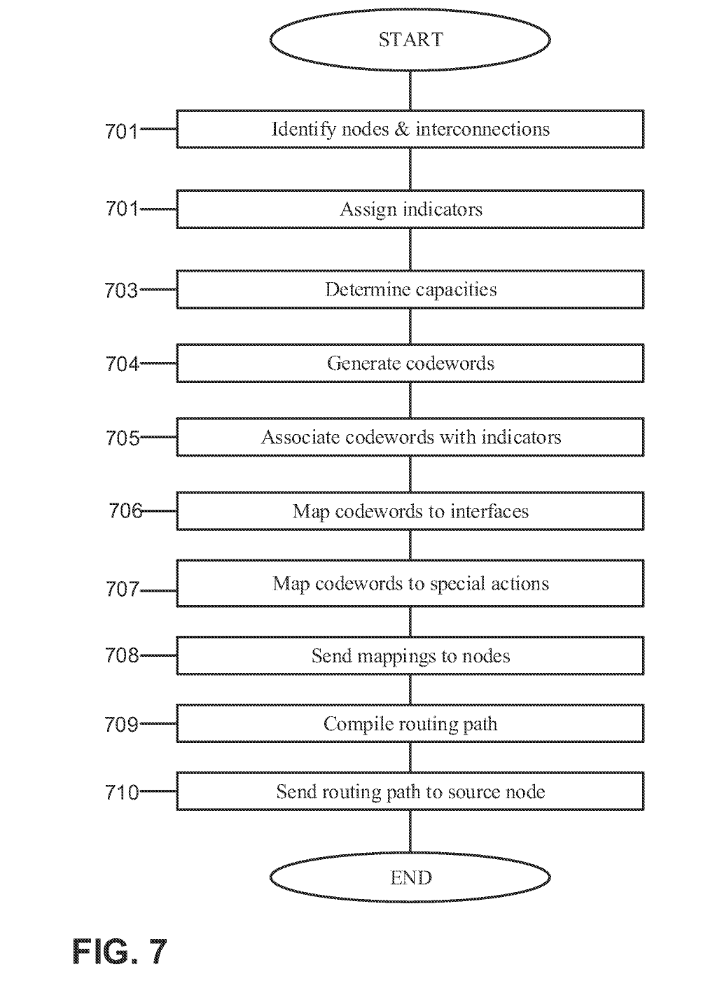

Referring now to FIG. 7, a process flow is illustrated that may be performed by central network controller 210 of FIG. 2 to implement an embodiment of the method described in this disclosure for encoding source routing. The process begins at block 701, where communication network nodes and interconnects, including, for example, links and interfaces are discovered, or identified. In block 702, indicators are assigned to the interconnects associated with each node in the network, as described above.

In block 703, the value of an optimization parameter, such as capacity, historical traffic flow, or predicted future traffic flow, is determined with regard to each interconnect, as explained above. Codewords are generated, in block 704, and assigned to, or associated with, the indicators, in block 705, as described above. The codewords are mapped to network interfaces, such as local port numbers associated with the nodes, in block 706, as described above. For example, variable-length codewords can be optimized to encode network interfaces or links for forwarding the packet over the network.

In block 707, additional codewords may optionally be mapped to special actions, as explained above. The mappings are sent to each of the network nodes, in block 708, as described above. Of course, as explained above, in an alternative embodiment the central controller downloads to each individual node only a subset of the codewords. In block 709, an encoded source routed path from a network source node to a network destination node is compiled, as described above. The routing path is sent to the source node, in block 710.

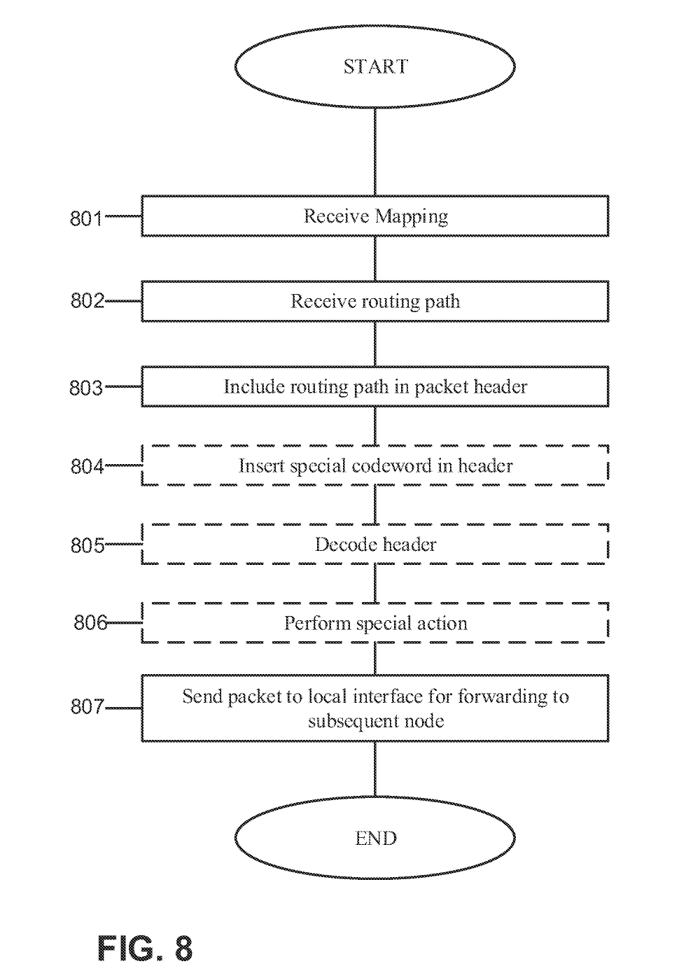

FIG. 8 illustrates a process flow that can be performed, for example, by one or more of the nodes of FIG. 2 to implement an embodiment of the method described in this disclosure for encoding source routing. The process begins at block 801, where mappings of codewords to network interfaces and links, as well as to special actions, are received, as described above. In block 802, a source routed path encoding is received, for example, at a network node.

In block 803, as explained above, the routing path is included in a network message packet header for forwarding over a network, and in block 804 an additional special codeword is optionally inserted in the packet header. As described above, the packet header is decoded, in block 805, and in block 806 a special action is optionally performed. In block 807, as explained above, the packet is sent to a local interface at one of the network nodes for forwarding to a subsequent node.

Embodiments of the present invention can be used to optimize centralized control of network data packet flows while reducing overhead, thereby optimizing network convergence and reducing traffic between the central controller and the network nodes. In addition, software defined network (SDN) standards (for example, ONF OpenFlow) could be enhanced to configure edge nodes throughout the network with the source routing information.

Aspects of this disclosure are described herein with reference to flowchart illustrations or block diagrams, in which each block or any combination of blocks can be implemented by computer program instructions. The instructions may be provided to a processor of a general purpose computer, special purpose computer, or other programmable data processing apparatus to effectuate a machine or article of manufacture, and when executed by the processor the instructions create means for implementing the functions, acts or events specified in each block or combination of blocks in the diagrams.

In this regard, each block in the flowchart or block diagrams may correspond to a module, segment, or portion of code that including one or more executable instructions for implementing the specified logical function(s). It should also be noted that, in some alternative implementations, the functionality associated with any block may occur out of the order noted in the figures. For example, two blocks shown in succession may, in fact, be executed concurrently, or blocks may sometimes be executed in a different order.

A person of ordinary skill in the art will appreciate that aspects of this disclosure may be embodied as a device, system, method or computer program product. Accordingly, aspects of this disclosure, generally referred to herein as circuits, modules, components or systems, may be embodied in hardware, in software (including firmware, resident software, micro-code, etc.), or in any combination of software and hardware, including computer program products embodied in a computer-readable medium having computer-readable program code embodied thereon.

In this respect, any combination of one or more computer readable media may be utilized, including, but not limited to, an electronic, magnetic, optical, electromagnetic, infrared, or semiconductor system, apparatus, or device, or any suitable combination of these. More specific examples of computer readable storage media would include the following non-exhaustive list: a portable computer diskette, a hard disk, a random access memory (RAM), a read-only memory (ROM), an erasable programmable read-only memory (EPROM), a Flash memory, a portable compact disc read-only memory (CD-ROM), an optical storage device, network-attached storage (NAS), a storage area network (SAN), magnetic tape, or any suitable combination of these. In the context of this disclosure, a computer readable storage medium may include any tangible medium that is capable of containing or storing program instructions for use by or in connection with a data processing system, apparatus, or device.

Computer program code for carrying out operations regarding aspects of this disclosure may be written in any combination of one or more programming languages, including object oriented programming languages such as Java, Smalltalk, C++, or the like, as well as conventional procedural programming languages, such as the “C,” FORTRAN, COBOL, Pascal, or the like. The program code may execute entirely on an individual personal computer, as a stand-alone software package, partly on a client computer and partly on a remote server computer, entirely on a remote server or computer, or on a cluster of distributed computer nodes. In general, a remote computer, server or cluster of distributed computer nodes may be connected to an individual (user) computer through any type of network, including a local area network (LAN), a wide area network (WAN), an Internet access point, or any combination of these.

It will be understood that various modifications may be made. For example, useful results still could be achieved if steps of the disclosed techniques were performed in a different order, and/or if components in the disclosed systems were combined in a different manner and/or replaced or supplemented by other components. Accordingly, other implementations are within the scope of the following claims.

What is claimed is:

1. A method of generating identifiers associated with a communication network having a plurality of nodes interconnected by a plurality of interconnects, said method comprising:
generating a plurality of identifiers corresponding to either said plurality of nodes or said plurality of interconnects, a length of each identifier of said plurality of identifiers based on a parameter of a corresponding node or interconnect; and
generating a mapping between said identifiers and said plurality of nodes or interconnects.

2. The method of claim 1, wherein said parameters are based on respective maximum capacities of said interconnects.

3. The method of claim 1, wherein said parameters are based on at least one of: historical data flows across said interconnects, measured current data flows across said interconnects, and predicted future data flows across said interconnects.

4. The method of claim 1, wherein said generating said plurality of identifiers further comprises using a Huffman coding process.

5. The method of claim 1, wherein said parameter is directly related to a respective statistical probability corresponding to a quantity of data traversing said corresponding interconnect over time.

6. The method of claim 5, wherein said length of each identifier is inversely related to said parameter.

7. The method of claim 1, further comprising generating an additional identifier to indicate a special action to be performed by a node.

8. The method of claim 1, wherein said interconnects comprise at least one of: a link between said nodes or an interface associated with at least one of said nodes.

9. The method of claim 1, further comprising sending at least a portion of said mapping to at least one node.

10. The method of claim 1, further comprising:
sending to a source node in said communication network an ordered set of identifiers corresponding to a sequence of interconnects from said source node to a destination node in said communication network.

11. A method of routing a packet over a communication network, said method comprising:
receiving a routing path for a packet, said routing path comprising an ordered set of variable length identifiers, said identifiers corresponding to a sequence of interconnects from said node to a destination node in said communication network; and
identifying a next hop for said packet based on said routing path.

12. The method of claim 11, further comprising routing said packet to said next hop.

13. The method of claim 12, wherein said node is a source node, said routing path is received from said central controller, and said subsequent node is an initial hop in said routing path.

14. The method of claim 11, wherein a length of each identifier of said identifiers is based on a parameter of a corresponding node or interconnect.

15. The method of claim 14, wherein said length of each identifier is inversely related to said parameter, said parameter being directly related to a respective statistical probability corresponding to a quantity of data traversing said interconnects over time.

16. The method of claim 11, further comprising:
decoding at least a portion of said header; and
performing a special action including at least one of: removing an identifier of said ordered set of said identifiers from said routing path; adding said identifier of said ordered set of said identifiers to a reverse routing path; adding said identifier of said ordered set of said identifiers to a traversed path list; converting said identifier of said ordered set of said identifiers to a post-processing identifier, wherein said identifier of said ordered set of said identifiers initially is a pre-processing identifier; processing said packet as an operations, administration and maintenance packet; removing said header and forwarding said packet based on an embedded header; sending said packet to a network controller; discarding said packet; and incrementing a counter in response to the decoded portion of said header.

17. The method of claim 11, further comprising inserting a special identifier into said header with said routing path, wherein said special identifier indicates at least one of: a next hop in said routing path; a beginning of a reverse routing path; an end of said reverse routing path; a beginning of a traversed path list; an end of said traversed path list; and an end of said routing path.

18. A device for generating identifiers associated with a communication network having a plurality of nodes interconnected by a plurality of interconnects, said device comprising:
a network controller configured to generate a plurality of identifiers corresponding to one of said plurality of nodes and said plurality of interconnects, and generate a mapping between said identifiers and said plurality of nodes or interconnects, a length of each identifier of said plurality of identifiers based on a parameter of a corresponding node or interconnect.

19. The device of claim 18, wherein the network controller is further configured to compile a routing path comprising an ordered set of identifiers from said plurality of identifiers corresponding to a sequence of interconnects of said interconnects from a source node in said communication network to a destination node in said communication network.

20. The computer program product of claim 18, wherein said length of each identifier is inversely related to said parameter, and said parameter is directly related to a respective statistical probability corresponding to a quantity of data traversing said corresponding interconnect over time.
